(19) United States
(12) Patent Application Publication
(10) Pub. No.: US 2005/0271947 A1
(43) Pub. Date: Dec. 8, 2005

(54) Separator, battery with separator and method for producing a separator

(76) Inventor: Ove Nilsson, Kungalv (SE)

Correspondence Address: JACOBSON HOLMAN PLLC, 400 SEVENTH STREET N.W., SUITE 600, WASHINGTON, DC, 20004, US

(21) Appl. No.: 10/524,277

(22) PCT Filed: Aug. 28, 2003
(86) PCT No.: PCT/SE03/01337

§ 371 Date: Feb. 11, 2005

(30) Foreign Application Priority Data
Aug. 29, 2002 (SE) 0202553-4

(51) Int. Cl. H01M 2/16; B32B 5/16

(52) U.S. Cl. 429/251; 429/142; 428/323

(57) ABSTRACT

A separator for battery and including a plate shaped structure of inorganic fibers is distinguished in that said separator is impregnated with a dispersion of colloidal inorganic nano particles that have been enriched in the crossing points of the fibers when solvent has been dried so as to form binding agent. The invention also concerns a battery including such a separator with high pressure on the active material and a method for producing such a separator.

### FIELD OF THE INVENTION

The invention relates to a separator for a battery and a battery with at least one such separator. It also relates to a method for producing such a separator.

### DESCRIPTION OF PRIOR ART

Batteries for starting engines, lighting, auxiliary power and the like are electrochemical current sources having energy stored in electrodes. The electrodes form an electrochemical system consisting of at least one cathode (positive electrode connected to the positive pole of the battery), at least one anode (negative electrode connected to the negative pole of the battery) and electrolyte.

The most common storages system for the above purposes is the lead battery and the nickel-cadmium battery. Several other systems are under development, i.a. Ni-MH, which replaces the NiCd battery. Said battery systems have water based electrolyte but other systems require organic electrolyte and there are even batteries with salt melts.

If, for example, through a powerful mechanical force, a cathode and an anode in the same battery would be pressed together, short-circuit could occur. A short-circuit can be so powerful that an explosion takes place. Therefore it is almost always the case that a separator wall must be positioned between each cathode and anode. The separating wall (the separator) must be electrically non-conductive, but porous to the extent that a current can pass relatively unrestricted between the electrodes.

In certain constructions the separator may take up the entire distance between the electrodes, in particular if this distance is small. In some systems, for example in the lead battery, the electrolyte participates in the cell reactions and the amount of sulphuric acid must be adjusted to the capacity that is desired to extract from the battery. For that reason the electrode distance may be made extra large and it can be necessary to manufacture a separator having ribs. These ribs would be provided with such a height and construction that they support against the electrodes. Typical porosity of a separator intended for a battery having water based electrolyte can be 50-75%.

The material in the separator varies depending on the composition of the electrolyte. PVC is a common kind of material since it is chemically stable in acid as well as in alkaline electrolyte. In more advanced batteries, working at high temperatures, as an example boron nitride felt may be used. In some cases electrodes are arranged such that they are in a liquid form, for example the NaS battery, and when the electrolyte is comprised of solid Al₂O₃ the separator has been eliminated.

A particular material has come into use in lead batteries. I.e. micro fine fibers of chemically resistant glass (C-glass) are formed to a mat having the thickness 0.5 mm up to 2 mm and a porosity of about 95%. Such a mat may contain a large amount of acid electrolyte but can easily be pressed together. Thus, for example, a pressure of only about 80 kPa is necessary to press a glass wool separator (AGM-separator; AGM=Absorptive Glass Mat) from the thickness 1 mm to 0.5 mm.

An AGM-separator has two properties making it useful in lead batteries. The separator can, if it is put against the active material in the positive electrode, prevent loose particles from the electrode from falling down to the bottom of the battery container where, in that case, short-circuits could relatively easily appear.

The second advantageous property is the ability to have the sulphuric acid distributed in the pores of the separator also if the separator is not completely saturated with acid. This property makes it possible for the oxygen which is formed at the positive electrode during charging to pass through the separators and be reduced to water at the negative electrode so called oxygen gas recombination.

In particular in maintenance-free lead batteries these advantages are exploited, since it is possible to make the batteries closed with only a valve which opens if the gas pressure becomes too high. It is also possible to reach higher capacity per unit volume in that the so called sludge space below the electrodes and the space above the electrodes have been eliminated to a great extent.

The demands on the batteries and their application have resulted in many different constructions. Concerning lead batteries there are two main types: batteries having pasted, flat positive electrodes and batteries having positive tubular electrodes. The latter encloses the positive active material (PAM) in a porous housing and PAM surrounds a current supplier of lead or a lead alloy. The tube surrounding PAM is in itself a good support for the mass. A certain compression of PAM occurs in that the central current conductor corrodes and forms lead dioxide which has a greater volume than lead. It is well known that these tubular electrodes have a longer lifetime measured in numbers of cycles than the pasted flat electrodes. The reason for this is considered to be the pressure occurring through said expansion.

With repeated discharges of the electrodes in a lead battery, there is an expansion of the active material, whereby the electrodes will become more porous at the same time as the contact between the different particles becomes weaker. This expansion continues and goes on with a number of discharges until the internal particulate contact has been broken.

This effect can be counteracted by providing a mechanical pressure against the electrode surfaces during charging as has been described for tubular electrodes. A certain expansion should, however, be allowed in order that the active material be well utilized. Through the spring action of glass fibers in AGM separators this type of separator would be well suited for this purpose. When, however, there is most often a desire to make the separator as thin as possible in order to have the inner resistance in the battery minimized, such a separator would be pressed together so much that the spring action effect would cease. Higher pressures than 80 kPa are not common. Thin (pressed together) separators, i.e. 0.5 mm and there around bring about risk of short-circuit over dendrites.

### THE AIM AND THE MOST IMPORTANT FEATURES OF THE INVENTION

The aim of the present invention is to avoid the problems of the prior art and in particular to provide an improvement of the stability and manageability of the separator material as well as the capacity and lifetime of the battery.

This aim is obtained in a separator and a battery according to the above through the features of the characterizing portion of the respective independent claims.

Separators according to the invention can be subjected to high mechanical pressure during assembly without the structure of the separator collapsing.

Distinguishing for the invention is that the fibers in the separators are linked together in such a way that the separator can withstand mechanical load without losing the ability to essentially retain its initial thickness when the load is relieved. It is also the aim of the invention that the fibers are not to move with respect to each other. Further, the invention concerns producing separators that can withstand a load of up to 300 kPa.

It is also distinguishing for the invention that linking together of the fibers is achieved through enriching, concentrating of nano particles and, at drying the liquid phase (the solvent), subsequently binding together thereof and of the fibers in the crossing points.

According to the invention, said nano particles are supplied to the separators through addition of a dispersion of said particles in water or another solvent, whereupon the separators are dried. Hereby is thus formed a stable and permanent bonding of the particles to each other in the crossing points of the fibers which resists attack from the electrolyte used in the battery in question.

The term colloidal nano particles is intended to mean particles having such small size, in the nanometer area, that the particles are maintained dispersed in the used liquid so that there will be formed a stable colloid. The small size of the particles also contributes to the above mentioned stable and permanent bonding really being formed.

By the surface of the particles in question having surface bound groups with electrical charge, the particles will repel each other when they are dispersed in the liquid phase (the solvent). At the removal of the solvent the particles will come closer to each other and also to the fibers, and bonding bridges will be formed between the separate particles which lead to the inventive stabilization.

An impregnating liquid with a binding agent of preferably SiO₂, comprising said colloidal nano particles, is supplied to the separator in order to obtain impregnation of separators.

The invention is particularly applicable where a high mechanical pressure is applied on electrodes and separators. The invention can be applied in all batteries having separators but is described here in particular for bipolar lead batteries for long lifetime cycling.

Besides said drying process, through heat treatment of the enriched separator at temperatures between about 300° C. and 700° C. results in considerably more rigidity of the material in the crossing points and thereby a more stable separator.

Especially, the inorganic fibers are made of glass, which is an economic and technically useful material. In particular the separator according to the invention can include AGM material. By further the dispersion including SiO₂ in a water solution, a material is obtained which binds itself well onto the glass in the fibers as well as an economic and easily manageable dispersion.

By the binding agent comprising between about 20 and 60% of the total separator weight, a good balance between strength and resilience is achieved, which is accentuated when the binding agent preferably comprises between about 25 and 45% of the total separator weight.

The invention also concerns batteries, preferably bipolar lead batteries, assembled with separators according to the above and also preferably under high pressure.

Further advantages are achieved through other aspects of the invention.

It is previously known from JP 2001283810 by impregnation of AGM separators with a liquid containing dispersed particles to achieve separators having particles positioned between the glass fibers in order to obstruct penetration of dendrites. Hereby these separators may be made thinner than what is customary. Hereby there is thus no enrichment of the impregnating material in the crossing points of the fibers. It is not stated that an increased flexibility is achieved or that the separators per see could resist a higher pressure.

Another way of adapting the separator to a (small) electrode distance is described by Brecht (U.S. Pat. No. 5,091,275 Feb. 25, 1992). A binding agent of colloidal SiO₂ and a sulfate in water solution is supplied to the separator. The separator is dried in a compressed state whereby SiO₂ and the sulfate are united to a coagula. The separators are mounted in cells between electrodes and upon adding the acid, the binding agent is dissolved. Thereby the separator swells and provides good contact between electrode and separator. It is, however, evident from this document that this coagula is dissolved and is not binding together the glass fibers after supplying the acid.

An untreated AGM separator (AGM=Absorptive Glass Mat) intended herein consists to 100% of glass having high chemical strength. The fiber diameter may be <1 um for 90% of the material. A separator consisting of untreated AGM is mechanically weak and has low tear resistance, in particularly when it has been filled with sulphuric acid or water (wet strength). A certain flexibility can be observed in the untreated AGM separator: when it is loaded with weights and subsequently relived it will retain its initial thickness after a while if the load has not been so high that the glass fibers have been broken.

There is, however, a certain difference between loading of a dry and a wet separator. The wet separator will subsequently be somewhat less elastic and the pressure applied to electrodes and separators in production will be reduced.

The flexibility of the separators is, as mentioned above, essential for capacity as well as lifetime of the batteries. A separator should be able to maintain a high, constant pressure onto the active materials during the lifetime of the battery but at the same time have a flexibility allowing the expansion of the active materials following from discharge. When loading starts, thereafter, the separator should spring back in order to obtain a compression of the active materials back to initial thickness. The present invention is directed against achieving such flexibility.

Separators are often manufactured from plastics with a mix of pore making substances. The glass fiber separators can be bound with organic substances. Organic compounds in contact with PbO₂ should, however, be avoided since they subsequently are oxidized to CO₂ which makes oxygen gas recombination difficult in valve controlled batteries. According to the invention, only inorganic compounds are used as separator material and as impregnating agent (binding agent).

In order to achieve a mechanically strong separator having a certain flexibility and high porosity, according to a preferred embodiment of the invention, AGM separators are impregnated with a dispersion of colloidal SiO₂ in nano particle form.

Product having the trade name “BINDZIL” and “NYACOL” respectively, are manufactured by EKA Chemicals with different concentrations of SiO₂ and different particle sizes. Here has been chosen “BINDZIL 30/220” having particle diameter 15 nm but the invention is not for that reason limited to either this quality definition or this manufacturer but concerns also other kinds of dispersed colloidal nano particles.

The glass fibers in the basic material for said separators is loosely put in coils and gives to the separator a certain flexibility which occurs when glass treads are straightened out under applied pressure. The SiO₂ particles which through the dispersion are supplied to the separator will upon drying bind together the fibers in the crossing points and increased rigidity and resistant against mechanical pressure is obtained. Since not all fibers in the separator are bound in this way there is, however, a certain part of the flexibility left.

“BINDZIL 30/220” is a 30% solution with respect to the contents of SiO₂ and is before impregnation diluted to a solution including between 10 and 50% of BINDZIL 30/220, (corresponding to 3.5-16.4% by weight SiO₂) preferably 20% of BINDZIL 30/220 (corresponding to 6.9% by weight SiO₂) or thereabout. The solution is supplied to the separator in an amount of for example about 10 ml/100 cm² at a separator thickness of about 0.85 mm. The supplied volume may be modified and of course depends also on the thickness of the separator. It has been proved advantageous to use a solution which has been obtained through dilution of between 15 and 35% BINDZIL 30/220, preferably about 25-30%, since this brings about a preferred balance between rigidity, flexibility and remaining porosity which is suitable for most applications.

After drying at about 110° C. the separators, which before impregnation were soft and flexible as a fabric, now have become rigid but with certain flexibility. An additional rise of the temperature to at least 300° C. and up to about 700° C. gives a very rigid separator. Separators that have been impregnated this way can now be handled as plane sheets at assembly of the batteries. In case of glass fibers, temperatures in particular in the region about 500° C. are advantageous, since at higher temperatures the glass can be negatively affected.

The above defined percentages are related to BINDZIL 30/220. A more practical measure is to define percent added binding agent i.e. amount dry SiO₂. In table 1, therefore, “% BINDZIL” has been noted also as “gram SiO₂/gram glass”. The porosity in AGM separators is high (about 95-96%) and is effected very little by the added material. Here is also shown the relationship between amount SiO₂ and porosity.

TABLE 1

| BINDZIL | Surface weight | Binding agent | SiO₂/glass | Porosity |
|---|---|---|---|---|
| (%) *) | (g/m²) | (%) | (g/g) | (%) |
| 0 | 132 | 0 | 0 | 95 |
| 10 | 168 | 21 | 0.27 | 94.6 |
| 20 | 204 | 35 | 0.54 | 93.2 |
| 50 | 312 | 58 | 1.36 | 89 |

*) Concerns % BINDZIL 30/220 in water solution for example 20% = 20 ml BINDZIL + 8 + ml aq.dest.

In the displayed examples and in general it has been discussed here about micro glass as separator material. At occurrence separators may also be manufactured based from other mineral fibers. These may be bound together in the same way with colloidal SiO₂ but also with colloidal particles of Al₂O₃, Al(OH)₃, TiO₂ and moreover also most other metal oxides can be suitable binding agents and are therefore included in the invention. As an example Al₂O₃ fibers are bound by colloidal SiO₂ and also by Al(OH)₃ and TiO₂. A great number of other combinations of fiber materials—impregnation agents/binding agents can be used and are included in the invention.

The solvent for the colloidal SiO₂ is water with pH about 9.0. It is possible that also organic solvents could be used and the invention also includes these.

Lead batteries may be arranged such that PAM is subjected to a certain mechanical pressure which resists an expansion of PAM. At the same time as pressure is applied against PAM the same pressure occurs on the negative active material (NAM). Since NAM, which in a charged state is comprised of porous lead, is softer than PAM, NAM will be reduced in thickness if no measures are taken. In order to compensate for this drawback, according to the invention a pressure absorbing grid is included into the negative electrode.

Batteries with a pressure of up to 80 kPa on AGM separators placed between PAM and NAM are previously known. According to the invention it is possible to combine high mechanical application pressure on the electrodes with an impregnated separator of AGM type and a pressure resisting device at the negative electrode. This device may be a pressure molded grid or protrusions in the intermediate wall in bipolar batteries. In common batteries this pressure at the negative electrode is most often no problem, since NAM is supplied to the negative grid along its outer contour.

### DESCRIPTION OF EMBODIMENTS

The application of the invention will here be described in connection with a bipolar lead battery intended for discharging and charging with high current. This does, however, not limit the invention to this embodiment since it is considered that the invention may be adapted firstly to every other construction of lead batteries but also to other types of batteries. The drawings show:

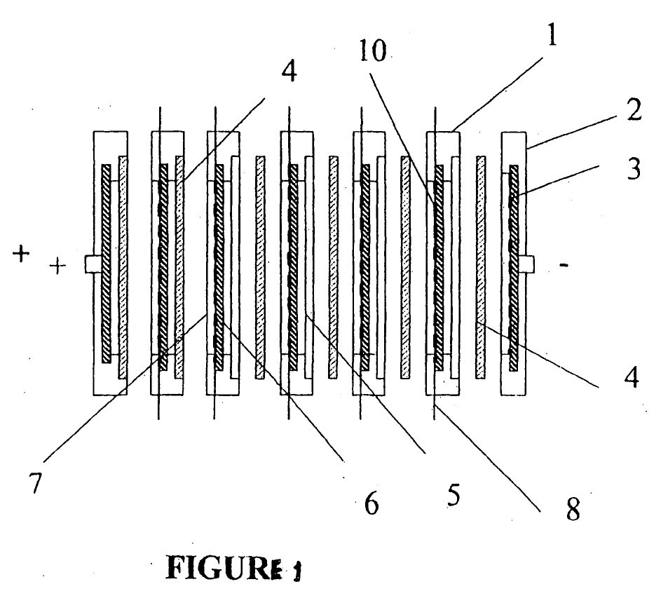

FIG. 1 diagrammatically a bipolar battery,

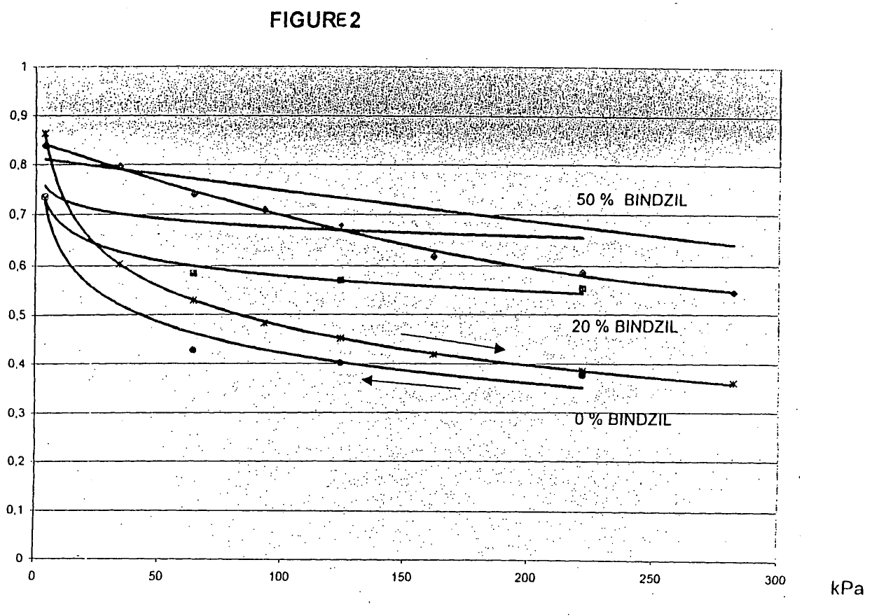

FIG. 2 in a diagram the compression of AGM separators with and without impregnation at increasing and decreasing load,

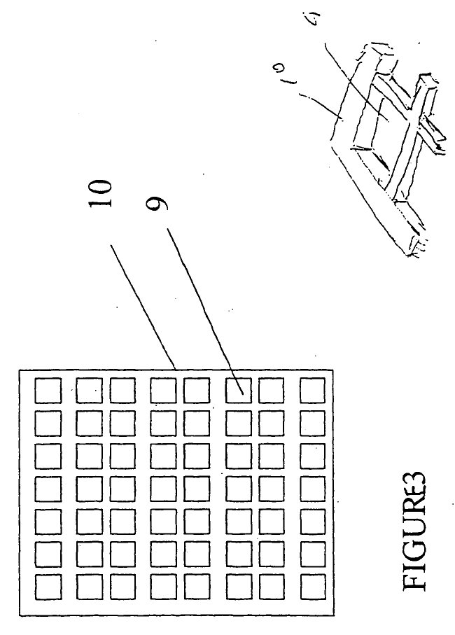

FIG. 3 a grid which is intended for resisting pressure at the negative electrode,

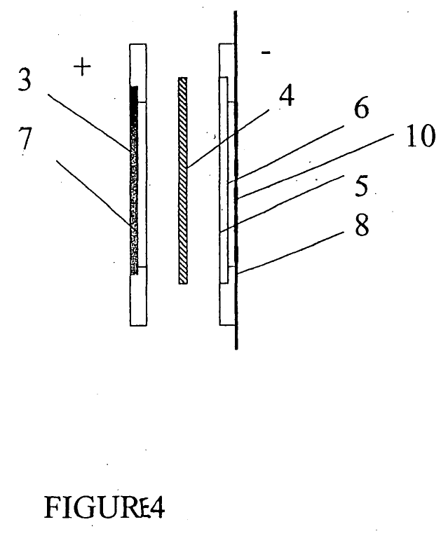

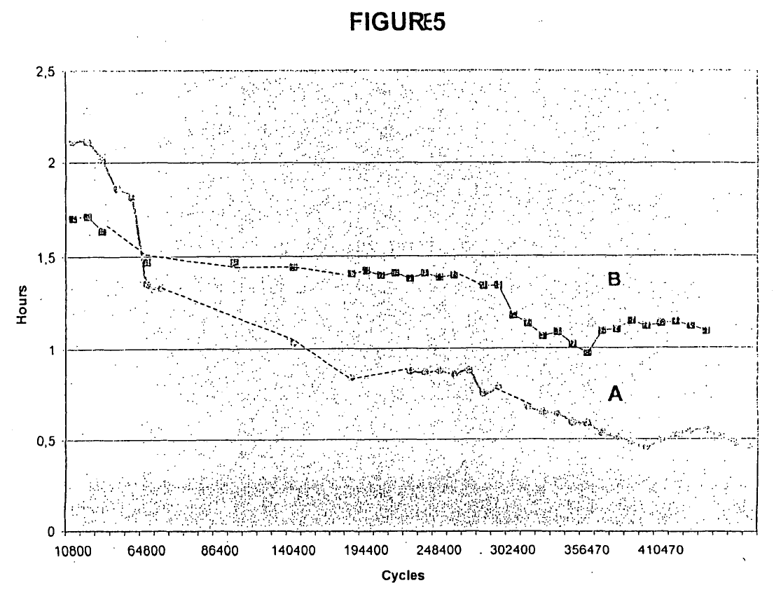

FIG. 4 a semi-bipolar battery unit,

FIG. 5 the lifetime of a bipolar battery having separators according to the invention,

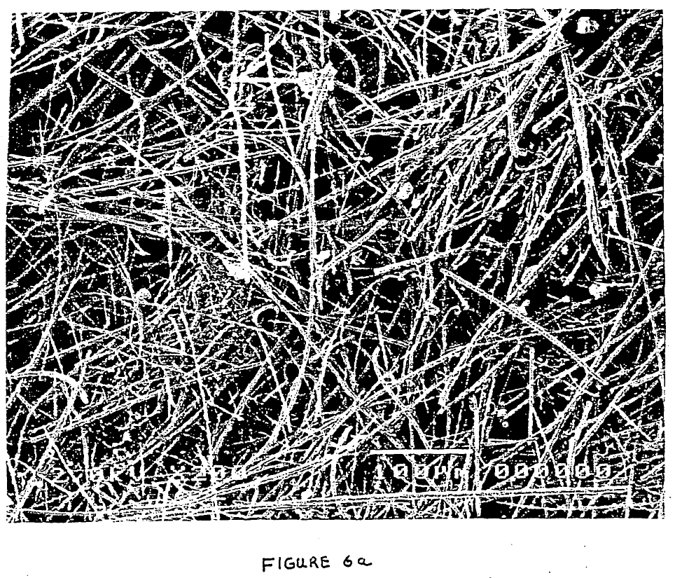

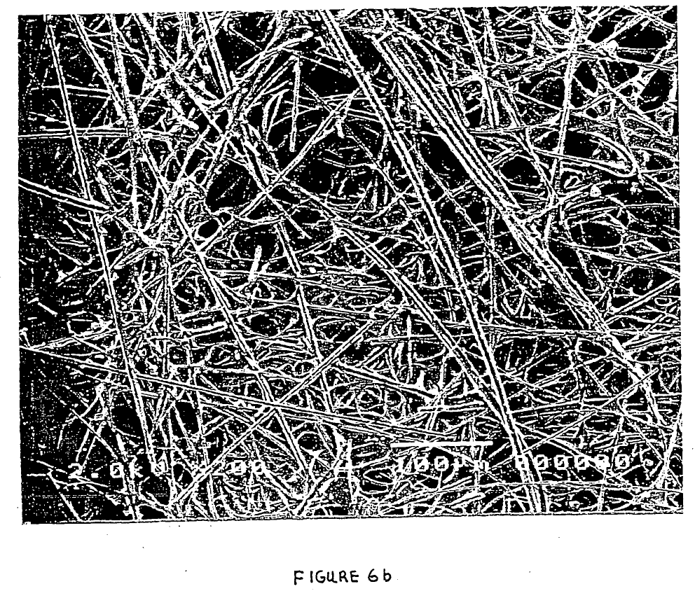

FIG. 6a an electron microscope photograph of glass fibers in an untreated glass fiber mat, and

FIG. 6b an electron microscope photograph of how SiO₂ binds together glass fibers a in glass fiber mat according to the invention.

What is said below about glass fibers formed into a separator for batteries is also true for other inorganic compounds that can be formed into fibers.

The invention concerns a reinforced separator for battery, batteries having said separators and a method of producing such separators. Such batteries can have a mechanical pressure on the electrodes of between about 80 and 250 kPa and a pressure resisting device in the negative part, preferably of plastic. The separators shall withstand said pressure without the material breaking and shall have a certain flexibility.

A battery for high currents corresponding to discharge times of about 0.5 to 1 minute for complete discharge should have a short electrode distance in order for the inner resistance inside a lead battery to be low. Further, the electrode and the other components of the battery should be constructed such that an even distribution of the current over the electrode surfaces is obtained. A preferred embodiment of such a battery can be a bipolar construction as for example is known from U.S. Pat. No. 5,510,211. This battery is constructed for said charging and discharging situation. It has been shown that a mechanical pressure of at least 150 kPa but preferably 200 kPa gives a battery with a good lifetime. The description of the invention will adjoin to said patent, but is for that reason not necessary bound to that construction.

With reference to FIG. 1, an electrode 1 for bipolar batteries includes an electron conducting wall 6 having PAM 5 and NAM 7 on each side of this wall. Each bipolar electrode 1, in particular in batteries according to said U.S. Pat. No. 5,510,211 is fitted in a frame 2 which is constructed such that it gives room for a separator 4. Five bipolar electrodes and two monopolar end electrodes 2 together form a 12 V bipolar battery. The walls 0.6 are comprised of porous chemical disks (for example 20×15 cm) the pores of which are filled with lead or a lead alloy in order to obtain electric conductivity.

The negative mass which comprises a mix of lead oxide, water, sulphuric acid and so called expander is applied in a wet state onto one side of the ceramic lead-filled disk which has a pressure relieving grid (see also FIG. 3; 9 concerns spaces for receiving the active mass in the structure 10) to a thickness of about 1 mm and not exceeding the thickness of the grid.

The positive mass may be comprised of a mix of water and pre-manufactured tetra basic lead sulphate (4PbO.PbSO₄) and is supplied at the other side of the bipolar electrode and against the lead filled porous ceramic disk. After drying a forming process is carried out whereupon the negative mass is transformed into porous Pb and the positive mass into porous PbO₂ in a way that is well known to person skilled in the art.

Separators 4 somewhat larger than the electrode surfaces and having a thickness of 0.85 mm are prepared with BINDZIL 30/220 as is described according to an example below. Separators are dried at 110° C. over night. At assembly, which is made with a separator between every electrode, the separators are compressed through the pressure to 0.7 mm.

After forming and rinsing, end electrodes are mounted having poles, bipolar electrodes and separators together into a pile and are pressed together with the aid of tension rods to pressure of 200 kPa.

Other pressures can be chosen wherein the separator is impregnated with a greater or smaller amount of BINDZIL in the impregnating liquid which is illustrated in FIG. 2. This figure shows the compression as a function of loading pressure. The load was increased stepwise with about 25-50 kPa until the separator was entirely compressed. Thereafter the separator was unloaded stepwise, whereby the thickness increased.

From the figure it is obvious that a non-impregnated separator is compressed to 0.7 mm already with about 15 kPa, whereas with a 20% BINDZIL (=0.42 g SiO₂/gram glass) 100 kPa is reached and with 50% BINDZIL (1.05 g/g) about 180 kPa. In order to reach the pressure 250 kPa with non-impregnated separators it is required to have two separators, each having the thickness 0.85 mm, that are compressed to 0.7 mm.

In another preferred embodiment, see FIG. 4, the bipolar electrode is produced in two halves. One half comprising the positive part of the bipolar electrode with active material applied on the lead-infiltrated ceramic disk, and the other comprising the negative part with active material put on a leaded copperplate 10 with a grid for pressure relief.

The electrode halves are included in a frame each and put together to form a space for the separator. A separator 4 according to the invention impregnated with BINDZIL is placed between these electrodes. The separator has a thickness of for example 0.85 mm and is compressed to 0.7 mm which requires a pressure of 200 kPa if the amount impregnation is 50% BINDZIL. These electrodes with their separator are sealed under compression with heat, or in any other manner which is well known to the person skilled in the art, into one unit of 2V. This unit and an optional number of units manufactured in the same way are put together into a pile and are driven against each other with tension rods so that good electric contact is obtained between all units.

By observation in an electronic microscope it can be clearly seen that most of the crossing points of the glass fibers have been locked by dried SiO₂, FIG. 6b. This locking is surprisingly stable, probably depending on that the basic material as well as the supplied suspension has the same basic composition. The chemical stability is also very good: a piece of AGM was impregnated with 30% BINDZIL 30/220 solution (corresponding to 0.52 g/g) and was given a number of 900 folds in wet state and was dried at 110° C. over night. The specimen was then kept in sulphuric acid having the density 1.30 for 12 months. No change of shape or ability to resist pressure could be observed after this time. As a comparison, in FIG. 6a a corresponding glass fiber structure is shown in untreated state.

### EXAMPLE 1

Two bipolar batteries of 4V with electrode surface of 16.6 cm² were mounted with on the one hand (A) two impregnated separators of AGM type, each of a thickness of 0.85 mm, on the other hand (B) a separator of AGM type, thickness 0.85 mm impregnated with 27% BINDZIL. The separators of both cells were compressed to 0.7 mm (electrode distance), the first battery with 250 kPa and the later with 150 kPa. The batteries were cycled as follows: 10 s discharge with 5.4 A+25 s charge with 2.16 A+5 s rest etc. for 20 hours, whereupon the batteries were fully charged during 4 hours. Thereafter the cycling continued. Every other week discharge was made with 0.3 A for determining capacity. The discharging time as a function of the number of cycles are shown in FIG. 5. From the figure is clear the considerable difference in practical lifetime of a battery according to the invention in comparison with a more conventional battery. In practice one treated separator is also superior to two which are untreated.

### EXAMPLE 2

A separator with 27% BINDZIL was manufactured by an un-impregnated separator of AGM type 20.5×13.5 cm×0.85 mm thick was put on a perforated aluminum plate which was somewhat larger than the separator. A BINDZIL solution was prepared by 27 ml BINDZIL 30/220 was diluted into 100 ml. 26 g of this solution was supplied to the separator from the centre towards the edges. Finally, the aluminum plate with the separator was put inclining and an additional 1 gram of the solution was applied along the upper edge. The separator was covered with an aluminum plate of the same kind as it was resting on. The separator was dried in an oven at 110° C. over night.

1. Separator for battery including a plate shaped structure of inorganic fibers, characterized in that said separator is impregnated with a dispersion of colloidal inorganic nano particles that have been enriched in the crossing points of the fibers so as to form binding agent when a solvent of the dispersion has dried.

2. Separator according to claim 1, characterized in that the separator has been heat treated at a temperature between 300 and 700° C. in order to obtain a considerably greater rigidity.

3. Separator according to claim 1 or 2, characterized in that the inorganic fibers comprise material of any of the group: glass fiber, mineral fiber, metal fiber.

4. Separator according to claim 1, 2 or 3, characterized in that the binding agent includes any of the group: SiO₂, Al₂O₃, Al(OH)₃, TiO₂.

5. Separator according to any of the previous claims, characterized in that the binding agent comprises between about 20% and 60% of the total separator weight.

6. Separator according to claim 5, characterized in that the binding agent comprised between about 25 and 45% of the total separator weight.

7. Battery with positive and negative electrodes, separators and electrolyte, characterized in that it includes at least one separator according to any of the claims 1-6.

8. Battery according to claim 7, characterized in that it is mounted with a pressure at its electrodes of at least 100 kPa, preferably 150-250 kPa.

9. Battery according to claim 7 or 8, characterized in that binding agent has been supplied to the separator in such an amount that it is compressible to about 80% of its thickness at an outside applied pressure of between 80 and 250 kPa.

10. Battery according to claim 7, 8 or 9 in bipolar form, characterized in that a pressure relieving grid is positioned in each negative electrode.

11. Battery according to any of the claims 7-10, characterized in that it is comprised of a lead battery with sulphuric acid electrolyte.

12. Method of producing a separator for a battery, wherein a disk-shaped structure comprising inorganic fibres is used, characterized in that said separator is impregnated with a dispersion of colloidal inorganic nano particles which are enriched in the crossing points of the fibres so as to form binding agent when a solvent of the dispersion is made to dry.

13. Method according to claim 12, characterized in that drying of solvent is obtained through drying at raised temperature.

14. Method according to claim 12 or 13, characterized in that the separator after drying the solvent is heat treated at a temperature between 300 and 700° C. in order to obtain a considerably greater rigidity of the bond in said crossing points.

15. Method according to claim 12, 13 or 14, characterized in that the inorganic fibres including material from any of the group: glass fibres, mineral fibres, metal fibres are used.

16. Method according to any of claims 12-15, characterized in that binding agent from the group: SiO₂, Al₂O₃, Al(OH)₃, TiO₂ is used.

17. Method according to any of claims 12-16, characterized in that the binding agent is brought to comprise between about 20 and 60% of the total separator weight.

18. Method according to any of the claims 12-17, characterized in that the binding agent is brought to comprise between about 25 and 45% of the total separator weight.
